(19) United States
(12) Patent Application Publication
(10) Pub. No.: US 2015/0077647 A1
(43) Pub. Date: Mar. 19, 2015

(54) MULTIPLIER EXTENDED DISPLAY

(71) Applicant: JMT ouch Corp., Ltd., Hsinchu (TW)

(72) Inventor: Jeng-Maw CHIOU, Hsinchu (TW)

(73) Assignee: JMT ouch Corp., Ltd., Hsinchu (TW)

(21) Appl. No.: 14/030,873

(22) Filed: Sep. 18, 2013

(51) Int. Cl. G06F 3/041

(52) U.S. Cl. CPC G06F 3/0412
USPC 349/12

(57) ABSTRACT

A touch panel for a touch sensitive liquid crystal display is disclosed. The touch panel is a multiplier expandable with a combination of two or more independent basic conductive patterns. The combination of basic conductive patterns devised for a touch panel made the display profile diversified as building blocks. Different display profile can be made including but not limited to landscape, portrait, L, T, U, C, Z, N, and cross. The combination of basic conductive patterns devised for a touch panel also simplifies the structure of a touch sensitive expandable display system and therefore shorten the timing for developing new large touch sensitive display products.

### BACKGROUND

1. Technical Field

The present invention relates to a touch panel for a touch sensitive liquid crystal display. Especially for a multiplier expandable touch panel with a combination of two or more independent basic conductive pattern.

2. Description of Related Art

FIG. 1 is a first prior art

FIG. 1 shows a touch sensitive display system for a prior art. A touch panel 11 is configured on a bottom side of a protective cover glass 10. A liquid crystal display 12 is configured on the bottom side of the touch panel 11. The protective cover glass 10, touch panel 11, and liquid crystal display 12 have a similar size which is approximately with a width W and a height H. A touch panel controller 15 is electrically coupled to the touch panel 11. An operation system 18 has a first end electrically coupled to the touch panel controller 15 and has a second end electrically coupled to the liquid crystal display 12.

FIG. 2 is a conductive pattern for the touch panel of FIG. 1

FIG. 2 shows a plurality of conductive diamond 11X serially connected in a latitudinal direction to form X circuit 14, and a plurality of conductive diamond 11Y serially connected in a longitudinal direction to form Y circuit 13. The plurality of latitudinal diamond string interlocks with the plurality of longitudinal string but electrically isolated from each other within the touch panel.

The X circuit 14 and Y circuit 13 can be either made on the same surface or different surface on the touch panel. When the X circuit 14 and Y circuit 13 are made on the same surface, an electric isolation is configured between the cross point to isolate the two circuit. When the X circuit 14 is made on a first surface of the touch panel and Y circuit 13 is made on the second surface of the touch panel, the touch panel substrate functions as an electric isolation therebetween.

FIG. 3 is a display system for the prior art of FIG. 1

FIG. 3 shows a display system equivalent to FIG. 1 but from a different view.

FIG. 3 shows a conductive pattern 11P configured on the touch panel 11. The conductive pattern 11P is composed of latitudinal X circuit 14 and longitudinal Y circuit 13. The X circuit 14 and the Y circuit 13 are electrically coupled to the touch panel controller 15. The controller 15 is then electrically coupled to the operation system 18. The operation system 18 is electrically coupled to the liquid crystal display 12.

FIG. 4 is a display system equivalent to the prior art of FIG. 3

FIG. 4 shows a display system equivalent to FIG. 3 but from a different view. FIG. 4 shows a matrix circuit with a plurality of latitudinal X circuit 14 and a plurality of longitudinal Y circuit 13 configured on the touch panel 11. The matrix circuit is electrically coupled to the touch panel controller 15. The controller 15 is then electrically coupled to the operation system 18. The operation system 18 is electrically coupled to the liquid crystal display 12.

FIG. 5 is a second prior art

FIG. 5 shows a touch sensitive display system of a prior. FIG. 5 shows a touch panel 112 for the display is double sized in width 2 W while keep the height H still the same as that of FIG. 1. A liquid crystal display 122 with an approximate profile or view area is configured on the bottom side of the touch panel 112. A touch panel controller 152 is electrically coupled to the touch panel 112. An operation system 182 has a first end electrically coupled to the touch panel controller 152 and has a second end electrically coupled to the liquid crystal display 122.

FIG. 6 is a conductive pattern for the touch panel of FIG. 5

FIG. 6 shows a new conductive pattern suitable for the larger touch panel 112 which has a width of 2 W as compared with the touch panel 11 of FIG. 1, as an example, needs to be redesigned. FIG. 6 shows that a plurality of conductive diamond serially connected in a latitudinal direction forms X circuit 142, and a plurality of conductive diamond serially connected in a longitudinal direction forms Y circuit 132. The plurality of latitudinal diamond string interlocks with the plurality of longitudinal diamond string. The X circuit 142 and Y circuit 132 are electrically coupled to the touch panel controller 152. The controller 152 is then electrically coupled to the operation system 182. The operation system 182 is electrically coupled to the liquid crystal display 122.

The disadvantage for the prior art is that a new touch panel, new touch panel controller and new operation system need to be designed for a new display which has a different size. It is time-consuming in the re-design for those elements. It is a long desire for a research engineer to simplify the design and timing for a new product.

FIG. 7 is a display system for the prior art of FIG. 6

FIG. 7 shows a display system of FIG. 6 but from a different view. FIG. 7 shows a matrix circuit of X circuit 142 and Y circuit 132 on the touch panel 112. The matrix circuit is electrically coupled to the touch panel controller 152. The controller 152 is then electrically coupled to the operation system 182. The operation system 182 is electrically coupled to the liquid crystal display 122.

If an old component can be modified and re-used for a new product, the redesign job can be simplified and the redesign timing can be shortened. The present invention devises a basic conductive pattern for an expandable touch panel which simplifies the process of redesign for a new larger display, especially for a multiplier expandable display.

### BRIEF DESCRIPTION OF THE DRAWINGS

FIG. 1 is a first prior art

FIG. 2 is a conductive pattern for the touch panel of FIG. 1

FIG. 3 is a display system for the prior art of FIG. 1

FIG. 4 is a display system equivalent to the prior art of FIG. 3

FIG. 5 is a second prior art

FIG. 6 is a conductive pattern for the touch panel of FIG. 5

FIG. 7 is a display system for the prior art of FIG. 6

FIG. 8 is a basic conductive pattern for a touch panel according to the present invention

FIG. 9A is a first embodiment of a touch panel according to the present invention

FIG. 9B is a second embodiment of a touch panel according to the present invention

FIG. 9C is a third embodiment of a touch panel according to the present invention

FIG. 10A is a fourth embodiment of a touch panel according to the present invention

FIG. 10B is a fifth embodiment of a touch panel according to the present invention

FIG. 11A is a sixth embodiment of a touch panel according to the present invention

FIG. 11B is a seventh embodiment of a touch panel according to the present invention

FIG. 12A is a eighth embodiment of a touch panel according to the present invention

FIG. 12B is a ninth embodiment of a touch panel according to the present invention

FIG. 13 is a display system for the first embodiment according to the present invention

FIG. 14 is a system equivalent to the system of FIG. 13

FIG. 15 is a system equivalent to the system of FIG. 13 in a view of touch area

FIG. 16 is a display system for the second embodiment according to the present invention

FIG. 17 is a display system for the third embodiment according to the present invention

FIG. 18 is a second display system for the first embodiment according to the present invention

FIG. 19 is a second display system for the second embodiment according to the present invention

FIG. 20 is a second display system for the third embodiment according to the present invention

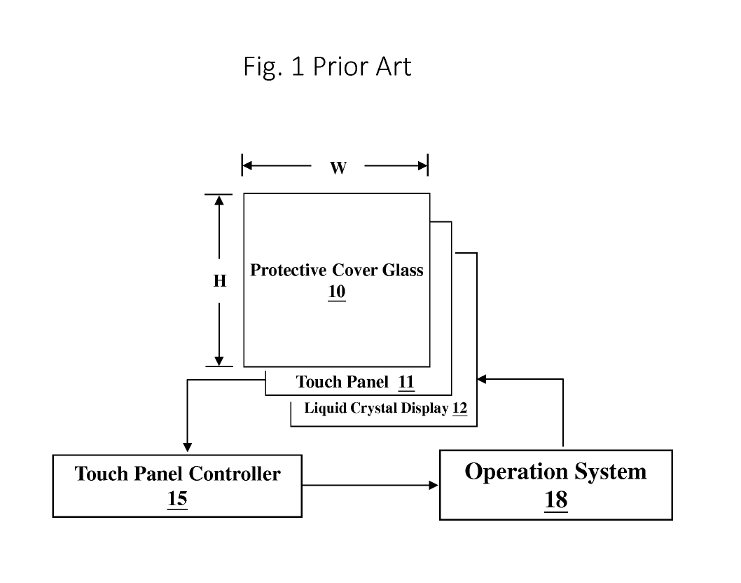

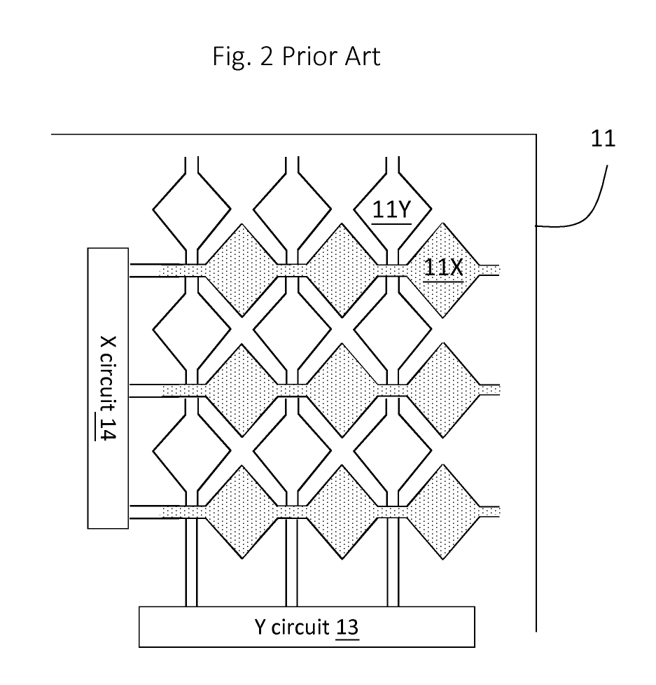

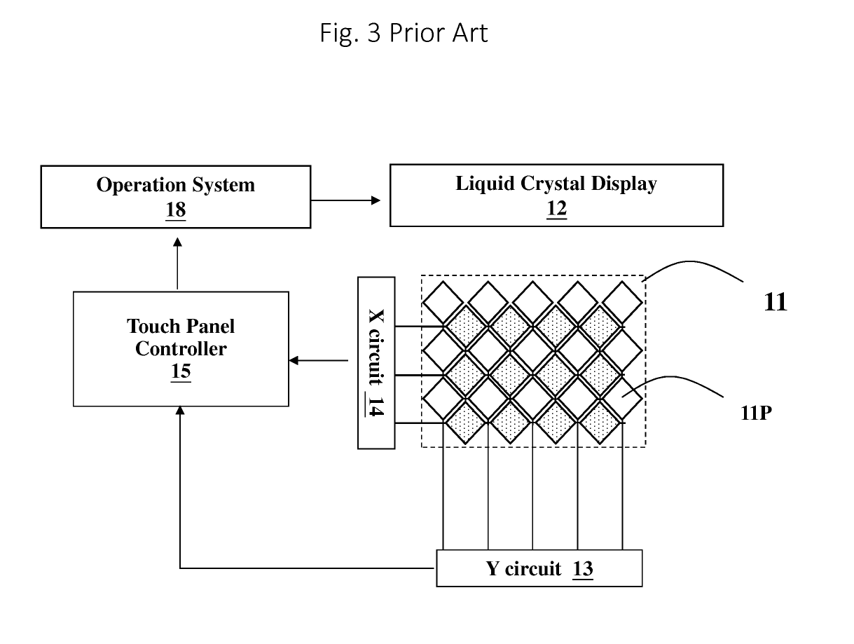

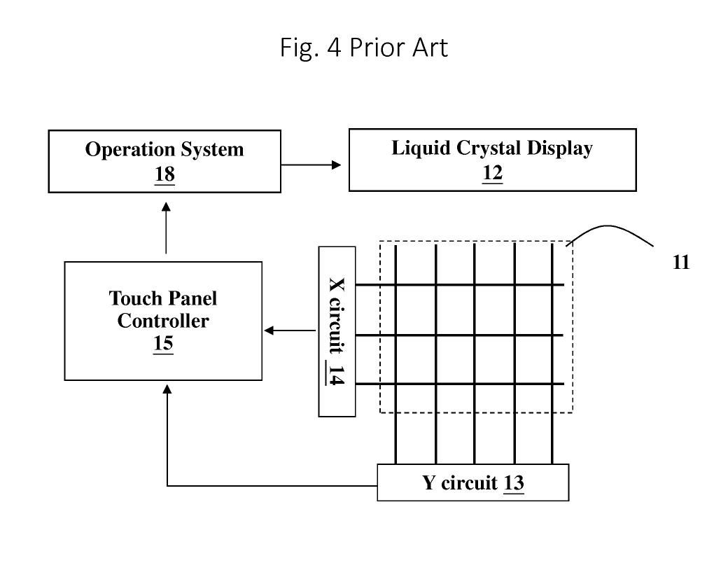

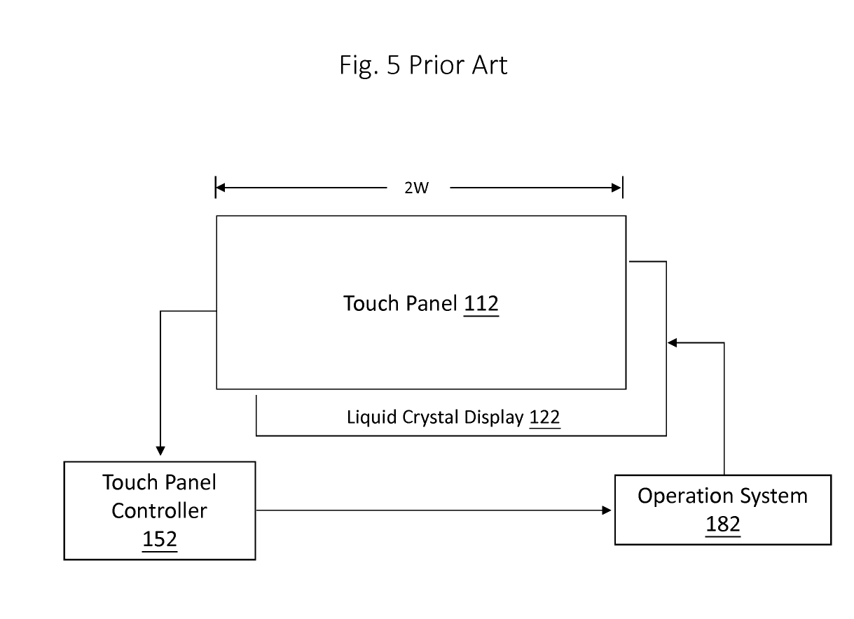

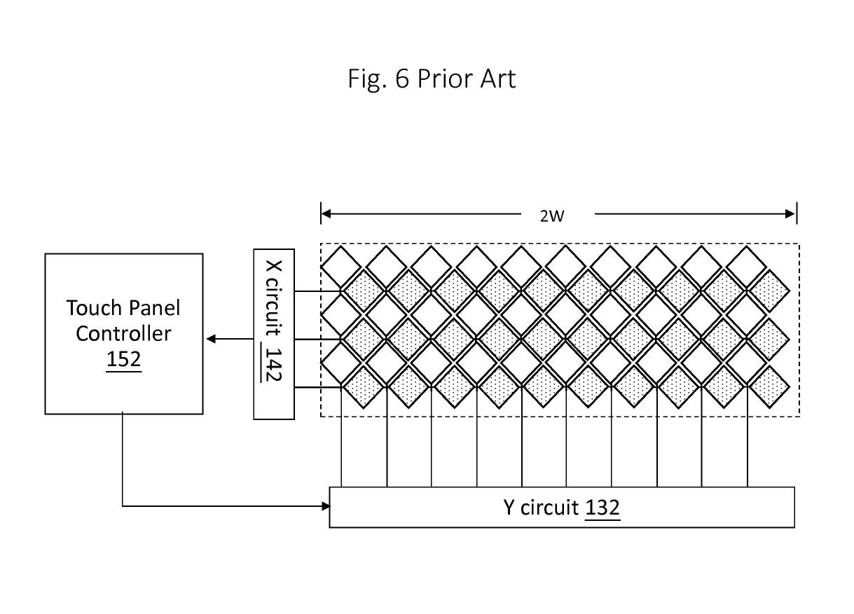

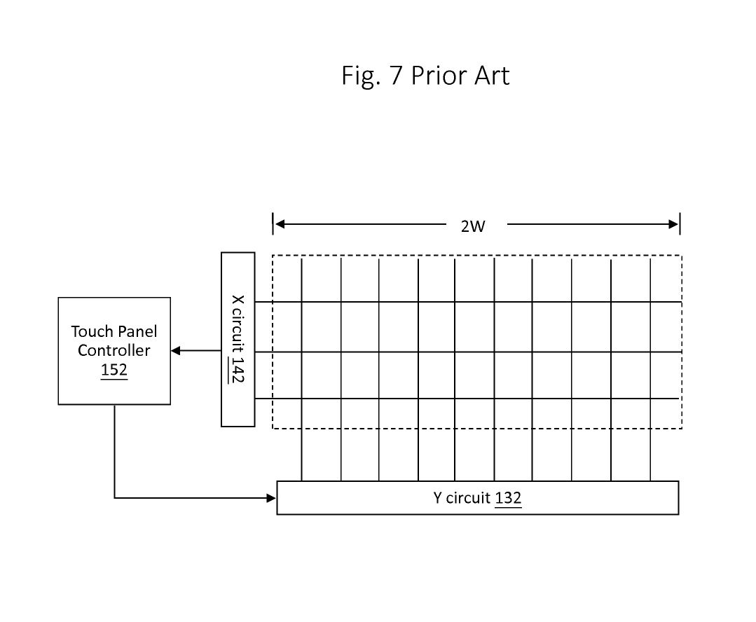

### DETAILED DESCRIPTION OF THE INVENTION

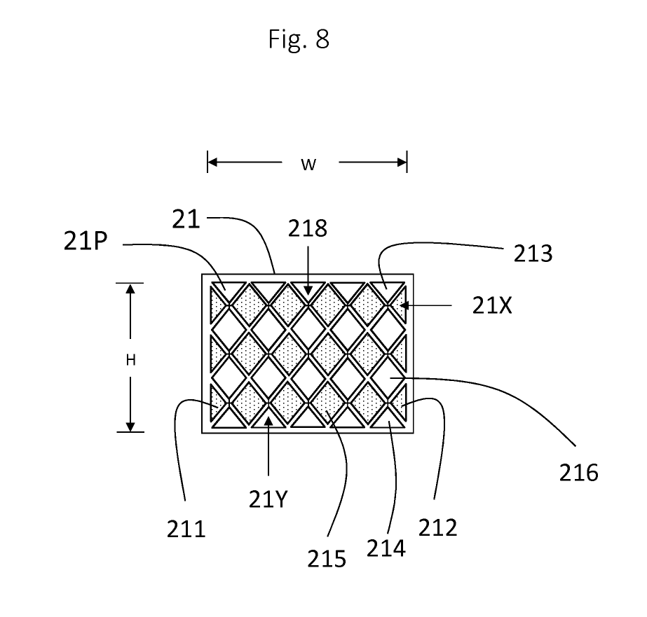

FIG. 8 is a basic conductive pattern for a touch panel according to the present invention

FIG. 8 is a basic conductive pattern 21P configured on a top surface of a touch panel 21. The touch panel 21 has a width W and a height H. The basic conductive pattern 21P has a plurality of latitudinal conductive pattern 21X and a plurality of longitudinal conductive pattern 21Y. The latitudinal conductive pattern 21X interweaves with the longitudinal conductive pattern 21Y. The latitudinal conductive pattern 21X is made electrically isolated with the longitudinal conductive pattern 21Y within the touch panel 21.

Each of the latitudinal conductive patterns 21X has a first conductive triangle 211 in a first position and a second conductive triangle 212 in a last position. A plurality of conductive diamond 215 is configured in between the first conductive triangle 211 and the last conductive triangle 212. The conductive diamonds 215 and the conductive triangles 211, 212 are serially connected with each apex in a latitudinal direction.

Each of the longitudinal conductive patterns 21Y has a third conductive triangle 213 in a first position and a fourth conductive triangle 214 in a last position. A plurality of conductive diamond 216 configured in between the third conductive triangle 213 and the fourth conductive triangle 214. The conductive diamonds 216 and the conductive triangles 213, 214 are serially connected with each apex in a longitudinal direction.

The latitudinal conductive pattern 21X and the longitudinal conductive pattern 21Y are interlocked and electrically isolated with each other. A sensing node 218 is formed in each cross point.

A fixed distance d1 is maintained between neighboring sensing nodes 218 in the latitudinal direction; and a fixed distance d2 is maintained between neighboring sensing nodes 218 in the longitudinal direction. Wherein, the distance d1 can be either the same as or different from the distance d2.

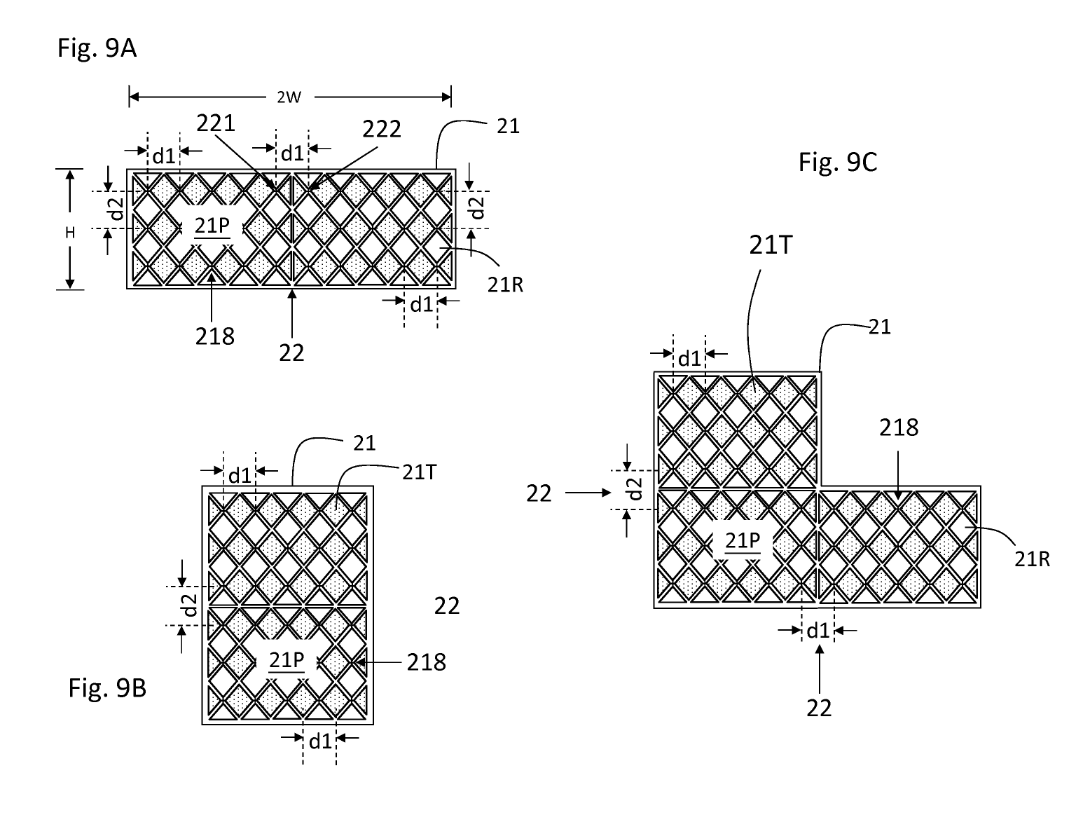

The basic conductive pattern of FIG. 8 facilitates itself to be added one or more basic conductive patterns latitudinally or longitudinally. For example, FIG. 9A shows a second basic conductive pattern 21R is added to the right side of the first basic conductive pattern 21P. FIG. 9B shows a second basic conductive pattern 21T is added to the top side of the first basic conductive pattern 21P. FIG. 9C shows a second basic conductive pattern 21R is added to the right side of the first basic conductive pattern 21P and a third basic conductive pattern 21T is added to the top side of the first basic conductive pattern 21P.

FIG. 9A is a first embodiment of a touch panel according to the present invention

FIG. 9A shows a touch panel 21 devised for a multiplier extended display with a doubled width 2 W and a height H. The touch panel 21 has two basic conductive patterns configured thereon. A boundary 22 without having any electronic element is located between neighboring basic conductive patterns. The touch panel 21 has a first basic conductive pattern 21P configured on the left side and a second basic conductive pattern 21R configured on the right side. The first basic conductive pattern 21P is electrically isolated from the second basic conductive pattern 21R on the touch panel. The first basic conductive pattern 21P forms a first touch area, and the second basic conductive pattern 21R forms a second touch area for a user. The first basic conductive pattern 21P and the second basic conductive pattern 21R are configured side by side in a latitudinal direction and electrically isolated with each other, to form a landscape touch panel for a landscape display.

The first basic conductive pattern 21P has a first matrix of sensing nodes 218. The second basic conductive pattern 21R has a second matrix of sensing nodes 218.

A fixed distance d1 is maintained between neighboring sensing nodes 218 in the latitudinal direction; and a fixed distance d2 is maintained between neighboring sensing nodes 218 in the longitudinal direction. Wherein, the distance d1 can be either the same as or different from the distance d2.

FIG. 9B is a second embodiment of a touch panel according to the present invention

FIG. 9B shows a touch panel 21 devised for a multiplier extended display with a width W and a doubled height 2H. The touch panel 21 has a first basic conductive pattern 21P, and a second basic conductive pattern 21T configured on a top side of the first basic conductive pattern 21P. The first basic conductive pattern 21P is electrically isolated from the second basic conductive pattern 21T on the touch panel.

A fixed distance d1 is maintained between neighboring sensing nodes 218 in the latitudinal direction; and a fixed distance d2 is maintained between neighboring sensing nodes 218 in the longitudinal direction. Wherein, the distance d1 can be either the same as or different from the distance d2.

The first basic conductive pattern 21P forms a first touch area, and the second basic conductive pattern 21T forms a second touch area for a user. The first basic conductive pattern 21P and the second basic conductive pattern 21T are configured side by side in a longitudinal direction and electrically isolated with each other to form a portrait touch panel for a portrait display.

FIG. 9C is a third embodiment of a touch panel according to the present invention

FIG. 9C shows a touch panel 21 devised for a multiplier extended display which is an L shaped display. The touch panel 21 is triple size extended with a combination of three basic conductive patterns.

FIG. 9C shows a first basic conductive pattern 21P which has a first matrix of sensing nodes 218. A second basic conductive pattern 21R which has a second matrix of sensing nodes 218 configured side by side on the right side and electrically isolated with the first basic conductive pattern 21P. A third basic conductive pattern 21T which has a third matrix of sensing nodes 218 configured on the top side and electrically isolated with the first basic conductive pattern 21P.

A fixed distance d1 is maintained between neighboring sensing nodes 218 in the latitudinal direction; and a fixed distance d2 is maintained between neighboring sensing nodes 218 in the longitudinal direction. Wherein, the distance d1 can be either the same as or different from the distance d2 within the touch panel.

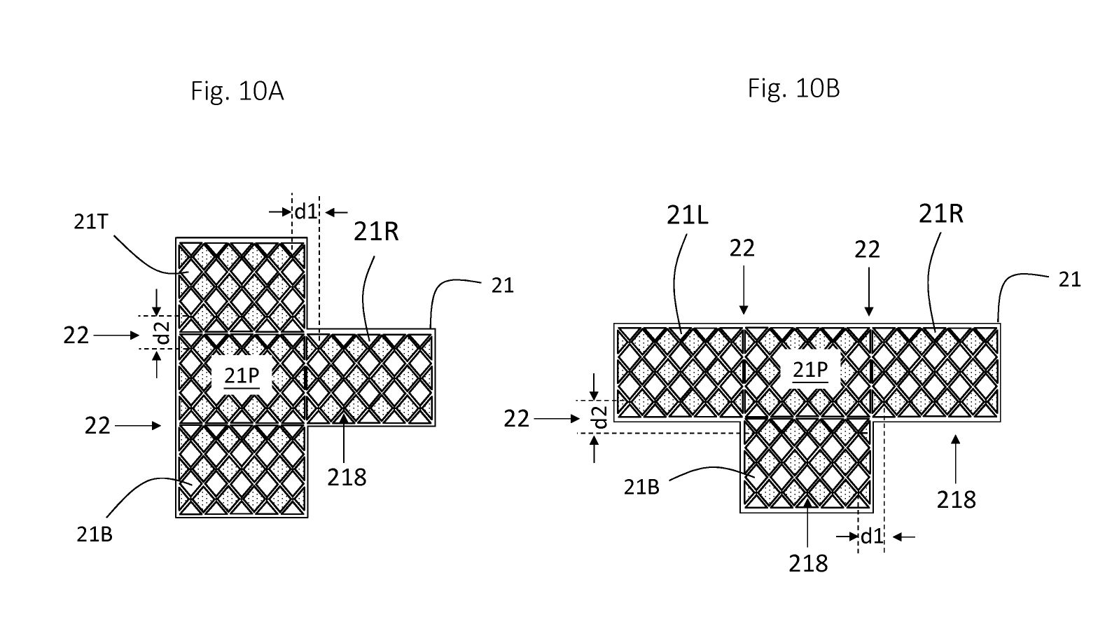

FIG. 10A is a fourth embodiment of a touch panel according to the present invention

FIG. 10A shows a touch panel 21 devised for a multiplier extended display with a T shape profile. The touch panel is quadruple size extended with a combination of four basic conductive patterns. A first basic conductive pattern 21P has a first matrix of sensing nodes 218. A second basic conductive pattern 21R having a second matrix of sensing nodes 218 is configured on a right side of the first basic conductive pattern 21P and electrically isolated with the first basic conductive pattern 21P. A third basic conductive pattern 21T having a third matrix of sensing nodes 218 is configured on a top side of the first basic conductive pattern 21P and electrically isolated with the first basic conductive pattern 21P. A fourth basic conductive pattern 21B having a fourth matrix of sensing nodes 218 is configured side by side on a bottom side and electrically isolated with the first basic conductive pattern 21P.

A fixed distance d1 is maintained between neighboring sensing nodes 218 in the latitudinal direction; and a fixed distance d2 is maintained between neighboring sensing nodes 218 in the longitudinal direction. Wherein, the distance d1 can be either the same as or different from the distance d2 within the touch panel.

FIG. 10B is a fifth embodiment of a touch panel according to the present invention

FIG. 10B shows a touch panel 21 devised for a T shaped display. The touch panel is quadruple size extended with a combination of four basic conductive patterns. A first basic conductive pattern 21P has a first matrix of sensing nodes 218. A second basic conductive pattern 21R having a second matrix of sensing nodes 218 is configured on a right side and electrically isolated with the first basic conductive pattern 21P. A third basic conductive pattern 21L having a third matrix of sensing nodes 218 is configured on a left side and electrically isolated with the first basic conductive pattern 21P. A fourth basic conductive pattern 21B having a fourth matrix of sensing nodes 218 is configured on a bottom side and electrically isolated with the first basic conductive pattern 21P.

A fixed distance d1 is maintained between neighboring sensing nodes 218 in the latitudinal direction; and a fixed distance d2 is maintained between neighboring sensing nodes 218 in the longitudinal direction. Wherein, the distance d1 can be either the same as or different from the distance d2 within the touch panel.

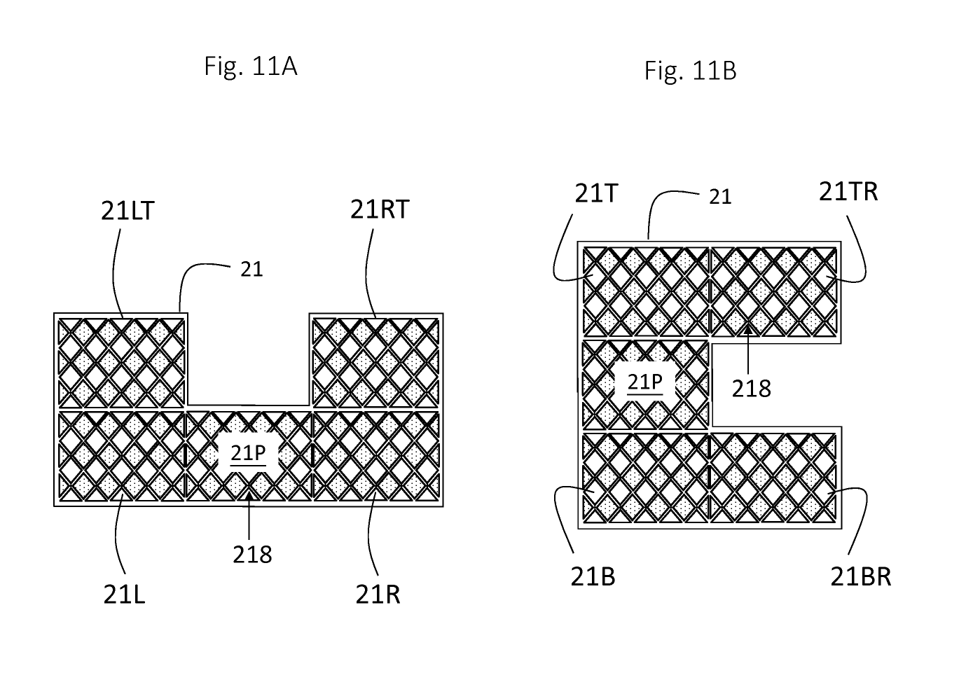

FIG. 11A is a sixth embodiment of a touch panel according to the present invention

FIG. 11A shows a touch panel 21 devised for a multiplier extended display which is quintuple size extended to form a U shaped display. A first basic conductive pattern 21P has a first matrix of sensing nodes 218. A second basic conductive pattern 21R having a second matrix of sensing nodes 218 configured on a right side and electrically isolated with the first basic conductive pattern 21P. A third basic conductive pattern 21L having a third matrix of sensing nodes 218 configured on a left side and electrically isolated with the first basic conductive pattern 21P. A fourth basic conductive pattern 21RT having a fourth matrix of sensing nodes 218 is configured on a top side and electrically isolated with the second basic conductive pattern 21R. A fifth basic conductive pattern 21LT having a fifth matrix of sensing nodes 218 is configured on a top side and electrically isolated with the third basic conductive pattern 21.

A fixed distance d1 is maintained between neighboring sensing nodes 218 in the latitudinal direction; and a fixed distance d2 is maintained between neighboring sensing nodes 218 in the longitudinal direction. Wherein, the distance d1 can be either the same as or different from the distance d2 within the touch panel.

FIG. 11B is a seventh embodiment of a touch panel according to the present invention

FIG. 11B shows a touch panel 21 devised for a multiplier extended display which is a quintuple size extended to form a C shaped display. A first basic conductive pattern 21P has a first matrix of sensing nodes 218. A second basic conductive pattern 21B having a second matrix of sensing nodes 218 is configured on a bottom side and electrically isolated with the first basic conductive pattern 21P. A third basic conductive pattern 21BR having a third matrix of sensing nodes 218 is configured on a right side and electrically isolated with the second basic conductive pattern 21B. A fourth basic conductive pattern 21T having a fourth matrix of sensing nodes 218 is configured on a top side and electrically isolated with the first basic conductive pattern 21P. A fifth basic conductive pattern 21TR having a fifth matrix of sensing nodes 218 is configured on a right side and electrically isolated with the third basic conductive pattern 21T.

A fixed distance d1 is maintained between neighboring sensing nodes 218 in the latitudinal direction; and a fixed distance d2 is maintained between neighboring sensing nodes 218 in the longitudinal direction. Wherein, the distance d1 can be either the same as or different from the distance d2 within the touch panel.

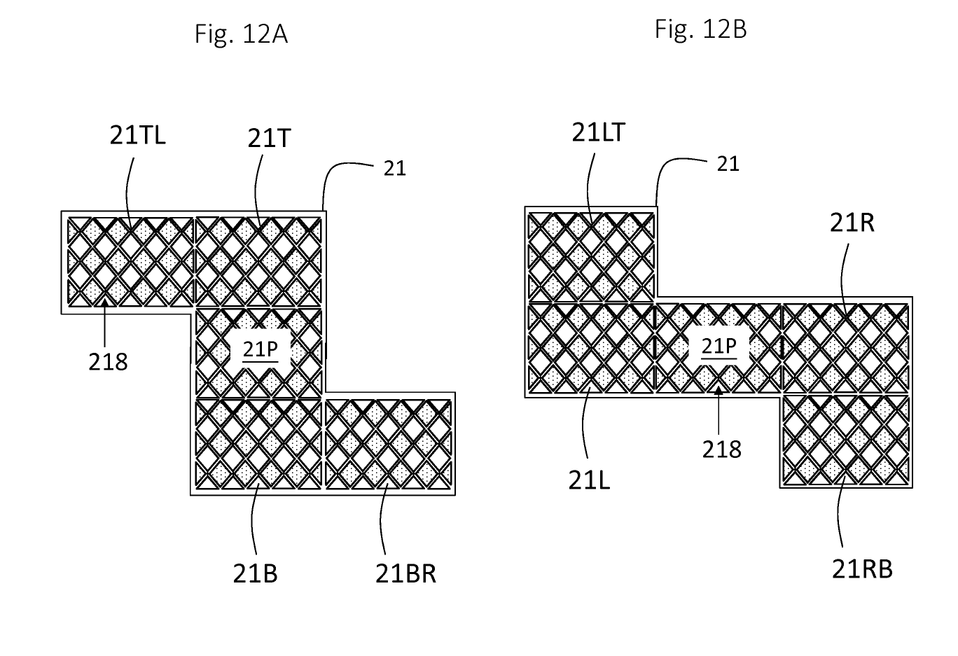

FIG. 12A is a eighth embodiment of a touch panel according to the present invention

FIG. 12A shows a touch panel 21 devised for a multiplier extended display which is quintuple size extended to form a Z shaped display. A first basic conductive pattern 21P has a first matrix of sensing nodes 218. A second basic conductive pattern 21B having a second matrix of sensing nodes 218 is configured on a bottom side and electrically isolated with the first basic conductive pattern 21P. A third basic conductive pattern 21BR having a third matrix of sensing nodes 218 is configured on a right side and electrically isolated with the second basic conductive pattern 21B. A fourth basic conductive pattern 21 having a fourth matrix of sensing nodes 218 is configured on a top side and electrically isolated with the first basic conductive pattern 21P. A fifth basic conductive pattern 21TL having a fifth matrix of sensing nodes 218 is configured on a left side and electrically isolated with the fourth basic conductive pattern 21T.

A fixed distance d1 is maintained between neighboring sensing nodes 218 in the latitudinal direction; and a fixed distance d2 is maintained between neighboring sensing nodes 218 in the longitudinal direction. Wherein, the distance d1 can be either the same as or different from the distance d2 within the touch panel.

FIG. 12B is a ninth embodiment of a touch panel according to the present invention

FIG. 12B shows a touch panel 21 devised for a multiplier extended display which has a N shaped profile. The touch panel 21 is quintuple size extended to form a N shaped display. A first basic conductive pattern 21P has a first matrix of sensing nodes 218. A second basic conductive pattern 21R having a second matrix of sensing nodes 218 is configured on a right side and electrically isolated with the first basic conductive pattern 21P. A third basic conductive pattern 21RB having a third matrix of sensing nodes 218 is configured on a bottom side and electrically isolated with the second basic conductive pattern 21R. A fourth basic conductive pattern 21L having a fourth matrix of sensing nodes 218 is configured on a left side and electrically isolated with the first basic conductive pattern 21P. A fifth basic conductive pattern 21LT having a fifth matrix of sensing nodes 218 is configured on a top side and electrically isolated with the fourth basic conductive pattern 21L.

A fixed distance d1 is maintained between neighboring sensing nodes 218 in the latitudinal direction; and a fixed distance d2 is maintained between neighboring sensing nodes 218 in the longitudinal direction. Wherein, the distance d1 can be either the same as or different from the distance d2 within the touch panel.

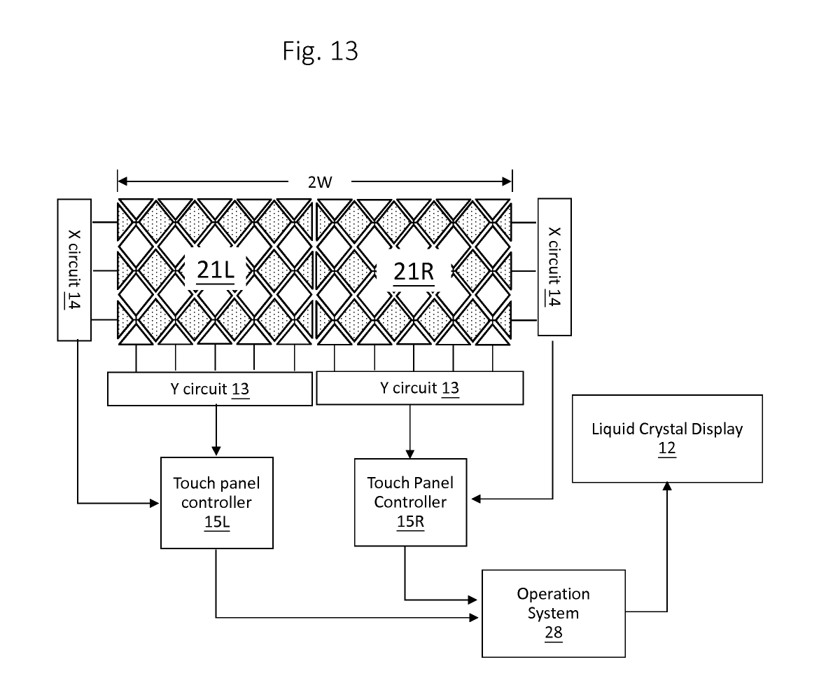

FIG. 13 is a display system for a landscape display according to the present invention

FIG. 13 shows a system devised for the landscape display of FIG. 9A. A first touch panel controller 15L is electrically coupled to the X circuit 14 and the Y circuit 13 of the first basic conductive pattern 21L. A second touch panel controller 15R is electrically coupled to the X circuit 14 and the Y circuit 13 of the second basic conductive pattern 21R. An operation system 28 has a first end electrically coupled to the first touch panel controller 15L, a second end electrically coupled to the second touch panel controller 15R, and a third end electrically coupled to the liquid crystal display 12.

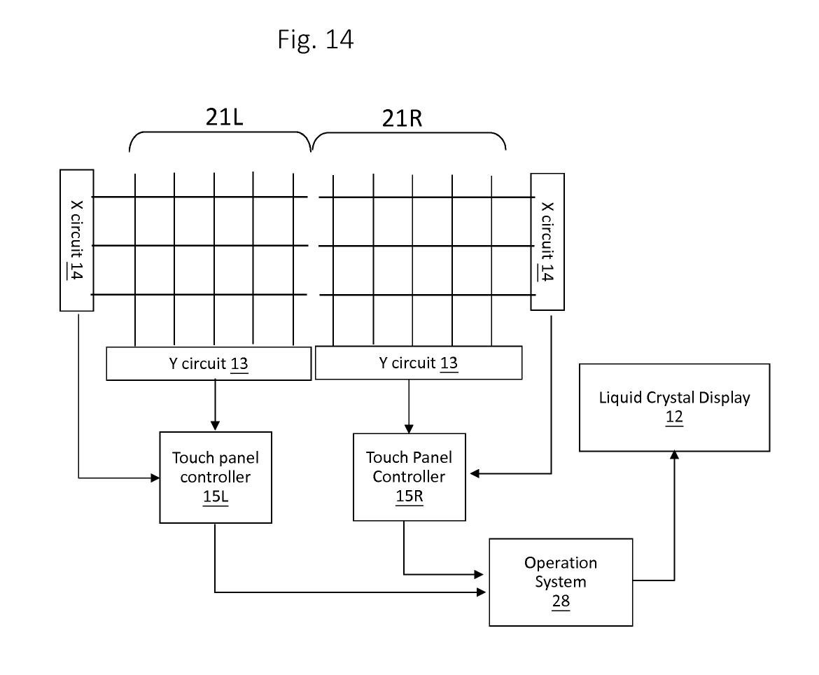

FIG. 14 is a system equivalent to the system of FIG. 13

FIG. 14 shows a first matrix circuit and a second matrix circuit, each equivalent to one of the conductive pattern 21L, 21R of FIG. 13. The rest components are the same as that in FIG. 13. The first matrix circuit is electrically isolated from the second matrix circuit on the touch panel.

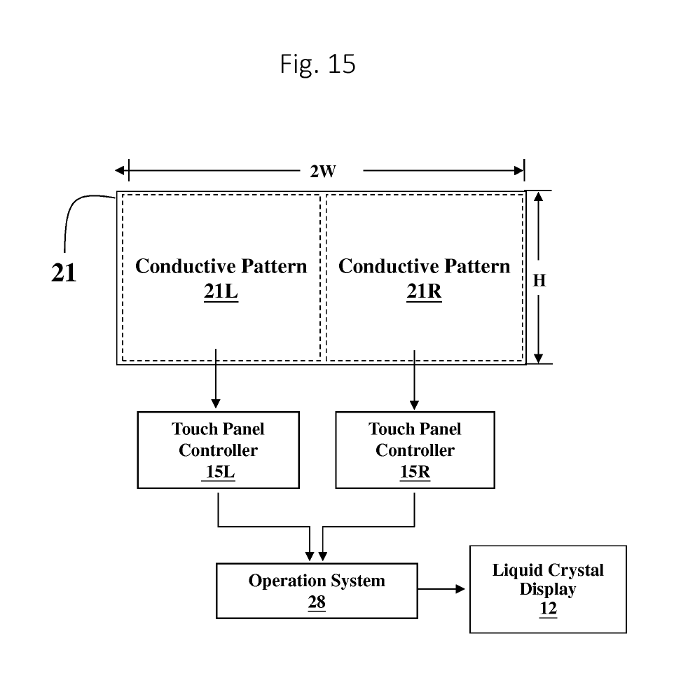

FIG. 15 is a system equivalent to the system of FIG. 13 in a view of touch area

FIG. 15 shows a touch panel 21 has a first basic conductive pattern 21L and a second basic conductive pattern 21R configured thereon. The first basic conductive pattern 21L forms a first touch area. The second basic conductive pattern 21R forms a second touch area. The rest elements are the same as that of FIG. 14.

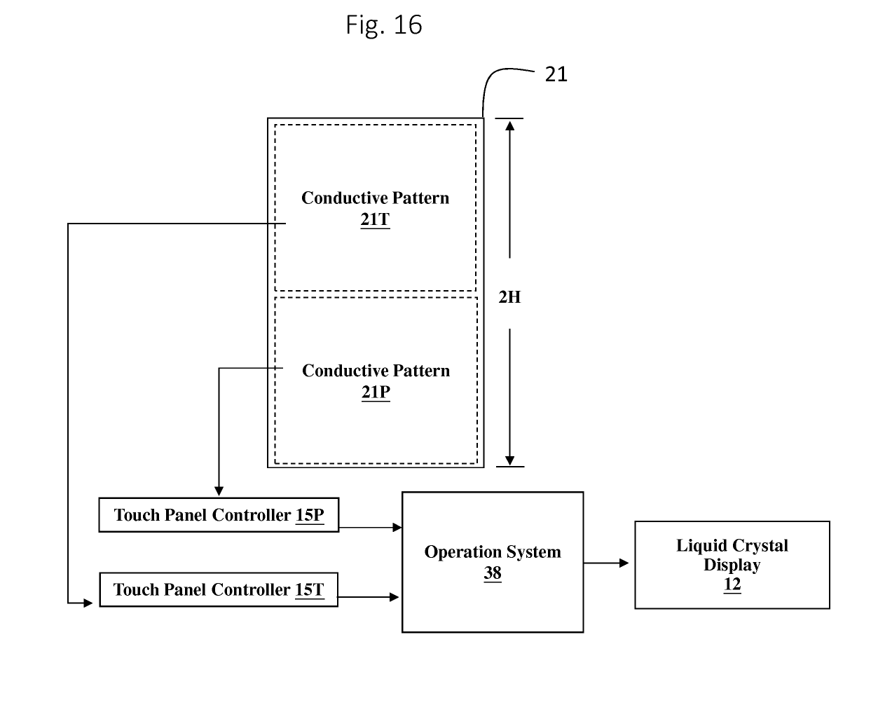

FIG. 16 is a display system for a portrait display according to the present invention.

FIG. 16 shows a touch panel 21 devised for a multiplier extended display which is a portrait display. A touch panel 21 has a first basic conductive pattern 21T which forms a first touch area; a second basic conductive pattern 21P which forms a second touch area. A first touch panel controller 15T is electrically coupled to the first basic conductive pattern 21T. A second touch panel controller 15P is electrically coupled to the second basic conductive pattern 21P. An operation system 38 has a first end electrically coupled to the first touch panel controller 15T, a second end electrically coupled to the second touch panel controller 15P; and a third end electrically coupled to the liquid crystal display 12.

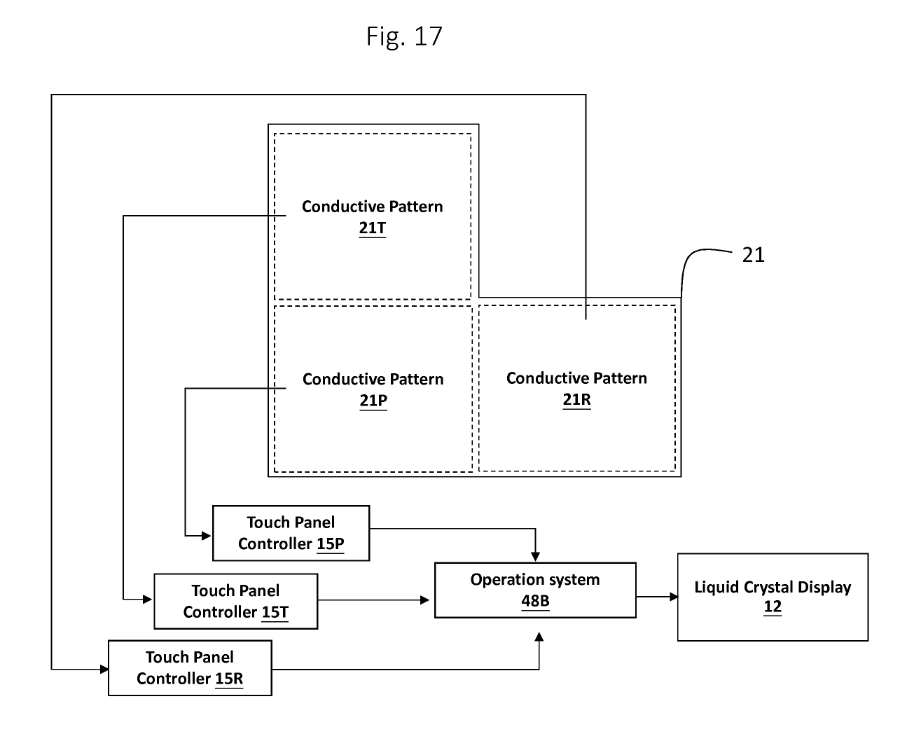

FIG. 17 is a display system for the third embodiment according to the present invention

FIG. 17 shows a touch panel 21 devised for a multiplier extended display which is an L shaped display. A first basic conductive pattern 21P which forms a first touch area; a second basic conductive pattern 21R which forms a second touch area. A third basic conductive pattern 21T which forms a third touch area. A first touch panel controller 15P is electrically coupled to the first basic conductive pattern 21P. A second touch panel controller 15R is electrically coupled to the second basic conductive pattern 21R. A third touch panel controller 15T is electrically coupled to the third basic conductive pattern 21T. An operation system 48B has a first end electrically coupled to the first touch panel controller 15P, a second end electrically coupled to the second touch panel controller 21R, a third end electrically coupled to the third touch panel controller 15T. A liquid crystal display 12 is electrically coupled to the operation system 48B.

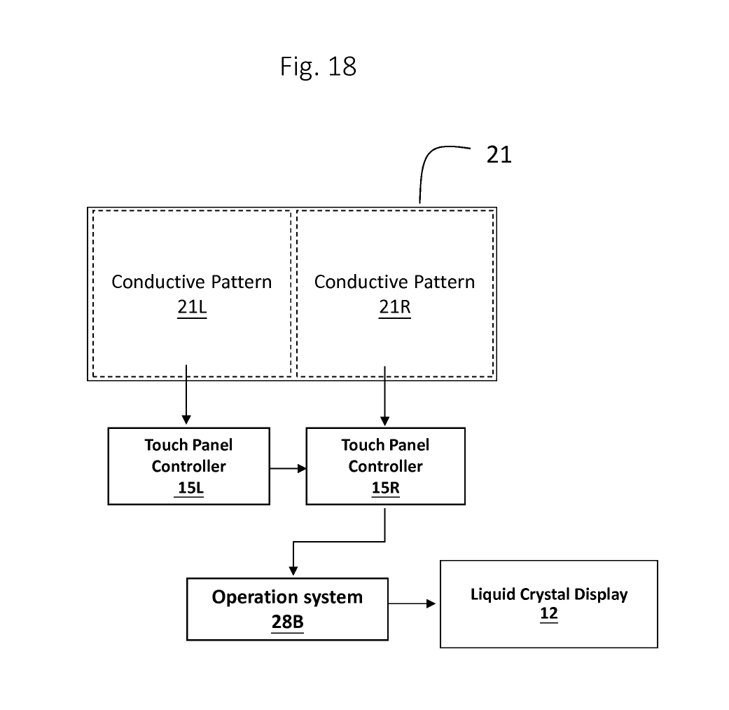

FIG. 18 is a second display system for the first embodiment according to the present invention

FIG. 18 shows a second display system for the landscape display. The difference between FIG. 18 and FIG. 15 is on the touch panel controller. FIG. 15 shows that the first touch panel controller 15L and the second touch panel controller 15R are parallelly coupled to the operation system 28. However, FIG. 18 shows that the first touch panel controller 15L and the second touch panel controller 15R are serially coupled before coupled to the operation system 28B. A first touch panel controller 15L electrically coupled to the first basic conductive pattern 21L. A second touch panel controller 15R has a first end electrically coupled to the first touch panel controller 15L, and having a second end electrically coupled to the second basic conductive pattern 21R. An operation system 28B has a first end electrically coupled to the second touch panel controller 15R and had a second end electrically coupled to the liquid crystal display 12. The first touch panel controller 15L is a slave controller; and the second touch panel controller 15R is a master controller.

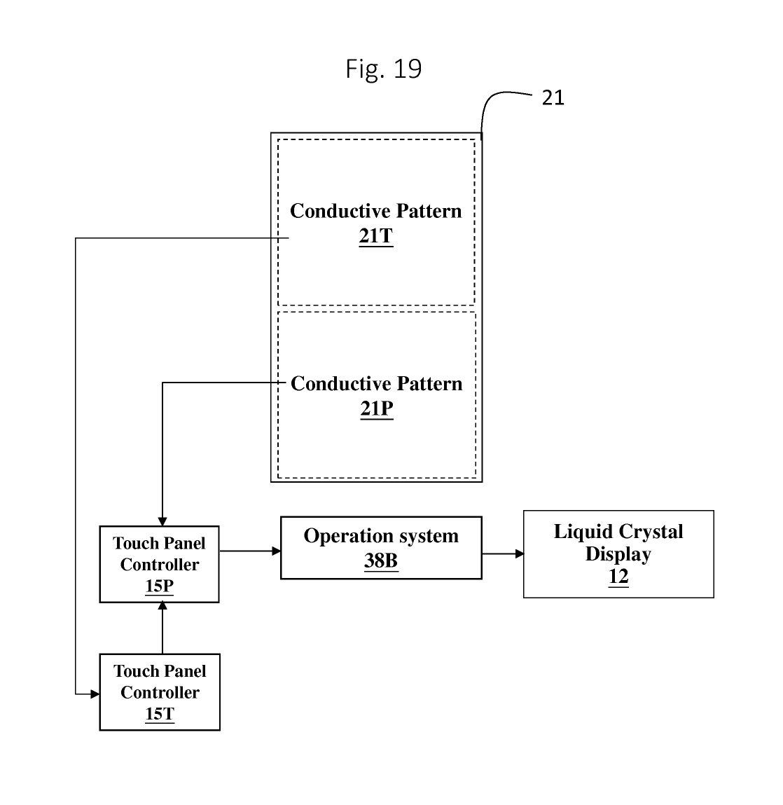

FIG. 19 is a second display system for the second embodiment according to the present invention

FIG. 19 shows a second display system for the portrait display. The difference between FIG. 19 and FIG. 16 is on the touch panel controller. FIG. 16 shows that the first touch panel controller 15T and the second touch panel controller 15P are parallelly coupled to the operation system 28. However, FIG. 19 shows that the first touch panel controller 15P and the second touch panel controller 15T are serially coupled.

A first touch panel controller 15P is electrically coupled to the first basic conductive pattern 21P. A second touch panel controller 15T has a first end electrically coupled to the second basic conductive pattern 21T and having a second end electrically coupled to the first touch panel controller 15P. An operation system 38B is electrically coupled to the first touch panel controller 15P. A liquid crystal display 12 is electrically coupled to the operation system 38B. The first touch panel controller 15P is a master controller and the second touch panel controller 15T is a slave controller.

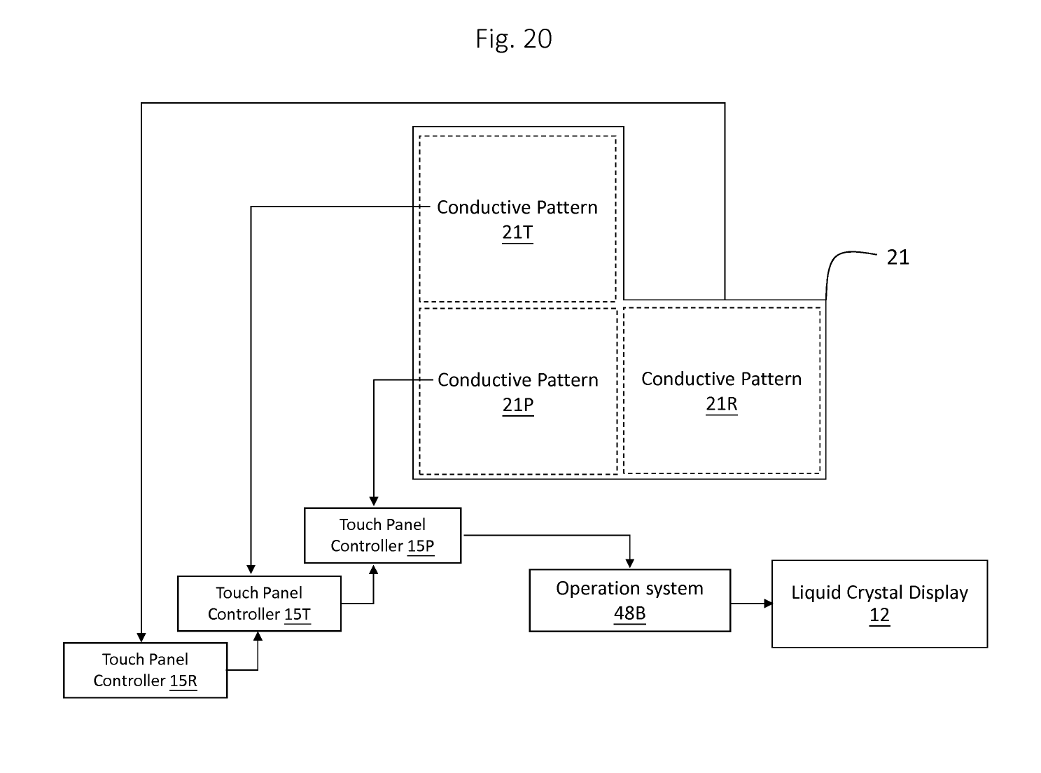

FIG. 20 is a second display system for the third embodiment according to the present invention

FIG. 20 shows a second display system for the L shaped display. The difference between FIG. 20 and FIG. 17 is on the touch panel controller. FIG. 17 shows that the first touch panel controller 15P, the second touch panel controller 15R, and the third touch panel 15T are parallelly coupled to the operation system. However, FIG. 20 shows that the first touch panel controller 15P, the second touch panel controller 15R, and the third touch panel controller 15T are serially coupled before the second one being coupled to the operation system 48B.

A first touch panel controller 15P is electrically coupled to the first basic conductive pattern 21P. A second touch panel controller 15R is electrically coupled to the second basic conductive pattern 21R. A third touch panel controller 15T is electrically coupled to the third basic conductive pattern 21T. The third touch panel controller 15T has a first end electrically coupled to the first touch panel controller 15P and has a second end electrically coupled to the second touch panel controller 15R. The second and the third touch panel controllers 15R, 15T are slave controllers and the first touch panel controller 15P is a master controller.

While several embodiments have been described by way of example, it will be apparent to those skilled in the art that various modifications may be configured without departing from the spirit of the present invention. Such modifications are all within the scope of the present invention, as defined by the appended claims.

What is claimed is:

1. A multiplier extended display, comprising:
a display;
a touch panel, configured on a top of the display, having an approximate view area as that of the display;
a conductive pattern, configured on the touch panel, further comprising:
a plurality of conductive diamond, configured in between a first conductive triangle and a last conductive triangle; wherein
the conductive diamonds and the conductive triangles are serially connected with each apex in a latitudinal direction; and
a plurality of conductive diamond, configured in between a third conductive triangle and a fourth conductive triangle; wherein
the conductive diamonds and the conductive triangles are serially connected with each apex in a longitudinal direction; wherein
the latitudinal string and the longitudinal string are interlocked and electrically isolated with each other; wherein
a sensing node is formed in each cross point, and
a fixed distance is maintained between neighboring sensing nodes.

2. A multiplier extended display as claimed in claim 1, wherein the touch panel is double size extended in width to form a landscape display, comprising:
a first basic conductive pattern, having a first matrix of sensing nodes;
a second basic conductive pattern, having a second matrix of sensing nodes which is the same as the one of the first basic conductive pattern; wherein,
the first basic conductive pattern and the second basic conductive pattern are configured side by side in a latitudinal direction and electrically isolated with each other;
a first fixed distance d1 is maintained between neighboring sensing nodes in a latitudinal direction; and a second fixed distance d2 is maintained between neighboring sensing nodes in a longitudinal direction; wherein, the first distance d1 can be either the same as or different from the second distance d2 within the touch panel.

3. A multiplier extended display as claimed in claim 1, wherein the touch panel is double size extended in height to form a portrait display, comprising:
a first basic conductive pattern, having a first matrix of sensing nodes;
a second basic conductive pattern, having a second matrix of sensing nodes; configured side by side in a longitudinal direction and electrically isolated with the first basic conductive pattern; wherein
a first fixed distance d1 is maintained between neighboring sensing nodes in a latitudinal direction; and a second fixed distance d2 is maintained between neighboring sensing nodes in a longitudinal direction; wherein, the first distance d1 can be either the same as or different from the second distance d2 within the touch panel.

4. A multiplier extended display as claimed in claim 1, wherein the touch panel is triple size extended to form an L shaped display, comprising:
a first basic conductive pattern, having a first matrix of sensing nodes;
a second basic conductive pattern, having a second matrix of sensing nodes; configured on a right side and electrically isolated with the first basic conductive pattern; and
a third basic conductive pattern, having a third matrix of sensing nodes; configured on a top side and electrically isolated with the first basic conductive pattern; wherein
a first fixed distance d1 is maintained between neighboring sensing nodes in a latitudinal direction; and a second fixed distance d2 is maintained between neighboring sensing nodes in a longitudinal direction; wherein, the first distance d1 can be either the same as or different from the second distance d2 within the touch panel.

5. A multiplier extended display as claimed in claim 1, wherein the touch panel is quadruple size extended to form a T shaped display, comprising:
a first basic conductive pattern, having a first matrix of sensing nodes;
a second basic conductive pattern, having a second matrix of sensing nodes; configured on a bottom side and electrically isolated with the first basic conductive pattern;
a third basic conductive pattern, having a third matrix of sensing nodes; configured on a bottom side and electrically isolated with the second basic conductive pattern; and
a fourth basic conductive pattern, having a fourth matrix of sensing nodes; configured side by side in a latitudinal direction and electrically isolated with the second basic conductive pattern; wherein
a first fixed distance d1 is maintained between neighboring sensing nodes in a latitudinal direction; and a second fixed distance d2 is maintained between neighboring sensing nodes in a longitudinal direction; wherein, the first distance d1 can be either the same as or different from the second distance d2 within the touch panel.

6. A multiplier extended display as claimed in claim 1, wherein the touch panel is quadruple size extended to form a T shaped display, comprising:
a first basic conductive pattern, having a first matrix of sensing nodes;
a second basic conductive pattern, having a second matrix of sensing nodes; configured on a right side and electrically isolated with the first basic conductive pattern;
a third basic conductive pattern, having a third matrix of sensing nodes; configured on a left side and electrically isolated with the first basic conductive pattern; and
a fourth basic conductive pattern, having a fourth matrix of sensing nodes; configured on a bottom side and electrically isolated with the first basic conductive pattern; wherein
a first fixed distance d1 is maintained between neighboring sensing nodes in a latitudinal direction; and a second fixed distance d2 is maintained between neighboring sensing nodes in a longitudinal direction; wherein, the first distance d1 can be either the same as or different from the second distance d2 within the touch panel.

7. A multiplier extended display as claimed in claim 1, wherein the touch panel is quintuple size extended to form a U shaped display, comprising:
a first basic conductive pattern, having a first matrix of sensing nodes;
a second basic conductive pattern, having a second matrix of sensing nodes; configured on a right side and electrically isolated with the first basic conductive pattern;
a third basic conductive pattern, having a third matrix of sensing nodes; configured on a left side and electrically isolated with the first basic conductive pattern;
a fourth basic conductive pattern, having a fourth matrix of sensing nodes; configured on a top side and electrically isolated with the second basic conductive pattern; and
a fifth basic conductive pattern, having a fifth matrix of sensing nodes; configured on a top side and electrically isolated with the third basic conductive pattern; wherein
a first fixed distance d1 is maintained between neighboring sensing nodes in a latitudinal direction; and a second fixed distance d2 is maintained between neighboring sensing nodes in a longitudinal direction; wherein, the first distance d1 can be either the same as or different from the second distance d2 within the touch panel.

8. A multiplier extended display as claimed in claim 1, wherein the touch panel is quintuple size extended to form a C shaped display, comprising:
a first basic conductive pattern, having a first matrix of sensing nodes;
a second basic conductive pattern, having a second matrix of sensing nodes; configured on a bottom side and electrically isolated with the first basic conductive pattern;
a third basic conductive pattern, having a third matrix of sensing nodes; configured on a right side and electrically isolated with the second basic conductive pattern;
a fourth basic conductive pattern, having a fourth matrix of sensing nodes; configured on a top side and electrically isolated with the first basic conductive pattern; and
a fifth basic conductive pattern, having a fifth matrix of sensing nodes; configured on a right side and electrically isolated with the fourth basic conductive pattern; wherein
a first fixed distance d1 is maintained between neighboring sensing nodes in a latitudinal direction; and a second fixed distance d2 is maintained between neighboring sensing nodes in a longitudinal direction; wherein, the first distance d1 can be either the same as or different from the second distance d2 within the touch panel.

9. A multiplier extended display as claimed in claim 1, wherein the touch panel is quintuple size extended to form a Z shaped display, comprising:
a first basic conductive pattern, having a first matrix of sensing nodes;
a second basic conductive pattern, having a second matrix of sensing nodes; configured on a bottom side and electrically isolated with the first basic conductive pattern;
a third basic conductive pattern, having a third matrix of sensing nodes; configured on a right side and electrically isolated with the second basic conductive pattern;
a fourth basic conductive pattern, having a fourth matrix of sensing nodes; configured on a top side and electrically isolated with the first basic conductive pattern; and
a fifth basic conductive pattern, having a fifth matrix of sensing nodes; configured on a left side and electrically isolated with the fourth basic conductive pattern; wherein
a first fixed distance d1 is maintained between neighboring sensing nodes in a latitudinal direction; and a second fixed distance d2 is maintained between neighboring sensing nodes in a longitudinal direction; wherein, the first distance d1 can be either the same as or different from the second distance d2 within the touch panel.

10. A multiplier extended display as claimed in claim 1, wherein the touch panel is quintuple size extended to form a N shaped display, comprising:
a first basic conductive pattern, having a first matrix of sensing nodes;
a second basic conductive pattern, having a second matrix of sensing nodes; configured on a right side and electrically isolated with the first basic conductive pattern;
a third basic conductive pattern, having a third matrix of sensing nodes; configured on a bottom side and electrically isolated with the second basic conductive pattern;
a fourth basic conductive pattern, having a fourth matrix of sensing nodes; configured on a left side and electrically isolated with the first basic conductive pattern; and
a fifth basic conductive pattern, having a fifth matrix of sensing nodes; configured on a top side and electrically isolated with the fourth basic conductive pattern; wherein
a first fixed distance d1 is maintained between neighboring sensing nodes in a latitudinal direction; and a second fixed distance d2 is maintained between neighboring sensing nodes in a longitudinal direction; wherein, the first distance d1 can be either the same as or different from the second distance d2 within the touch panel.

11. A multiplier extended display as claimed in claim 2, further comprising:
a first touch panel controller, electrically coupled to the first basic conductive pattern;
a second touch panel controller, electrically coupled to the second basic conductive pattern;
an operation system, having a first end electrically coupled to the first touch panel controller, a second end electrically coupled to the second touch panel controller; and
a liquid crystal display electrically coupled to the operation system.

12. A multiplier extended display as claimed in claim 3, further comprising:
a first touch panel controller, electrically coupled to the first basic conductive pattern;
a second touch panel controller, electrically coupled to the second basic conductive pattern;
an operation system, having a first end electrically coupled to the first touch panel controller, a second end electrically coupled to the second touch panel controller; and
a liquid crystal display electrically coupled to the operation system.

13. A multiplier extended display as claimed in claim 4, further comprising:
a first touch panel controller, electrically coupled to the first basic conductive pattern;
a second touch panel controller, electrically coupled to the second basic conductive pattern;
a third touch panel controller, electrically coupled to the third basic conductive pattern;
an operation system, having a first end electrically coupled to the first touch panel controller, a second end electrically coupled to the second touch panel controller, a third end electrically coupled to and the third touch panel controller; and
a liquid crystal display, electrically coupled to the operation system.

14. A multiplier extended display as claimed in claim 2, further comprising:
a first touch panel controller, electrically coupled to the first basic conductive pattern;
a second touch panel controller, having a first end electrically coupled to the first touch panel controller, and having a second end electrically coupled to the second basic conductive pattern;
an operation system, having a first end electrically coupled to the second touch panel controller;
a liquid crystal display electrically coupled to the operation system.

15. A multiplier extended display as claimed in claim 3, further comprising:
a first touch panel controller, electrically coupled to the first basic conductive pattern;
a second touch panel controller, having a first end electrically coupled to the second basic conductive pattern; and having a second end electrically coupled to the first touch panel controller;
an operation system, electrically coupled to the first touch panel controller;
a liquid crystal display, electrically coupled to the operation system.

16. A multiplier extended display as claimed in claim 4, further comprising:
a first touch panel controller, electrically coupled to the first basic conductive pattern;
a second touch panel controller, electrically coupled to the second basic conductive pattern;
a third touch panel controller, having a first end electrically coupled to the third basic conductive pattern; having a second end electrically coupled to the second touch panel controller; having a third end electrically coupled to the first touch panel controller;
an operation system, electrically coupled to the first touch panel controller; and
a liquid crystal display, electrically coupled to the operation system.

17. A multiplier extended display, comprising:
a touch panel;
a first touch area, configured on the touch panel;
a second touch area, configured on the touch panel, electrically isolated from the first touch area within the touch panel.

18. A multiplier extended display as claimed in claim 17, further comprising:
a first touch panel controller, electrically coupled to the first touch area;
a second touch panel controller, electrically coupled to the second touch area;
an operation system, having a first end electrically coupled to the first touch controller, a second end electrically coupled to the second touch panel controller; and
a liquid crystal display, electrically coupled to the operation system.

19. A multiplier extended display as claimed in claim 17, further comprising:
a first touch panel controller, electrically coupled to the first touch area;
a second touch panel controller, having a first end electrically coupled to the second touch area; and having a second end electrically coupled to the first touch panel controller;
an operation system, electrically coupled to the second touch controller; and
a liquid crystal display, electrically coupled to the operation system.

20. A multiplier extended display as claimed in claim 17, wherein a shape of the display is selected from a group consisting of landscape, portrait, L, T, U, C, Z, N, and cross.
